(19) United States
(12) Patent Application Publication
(10) Pub. No.: US 2008/0289663 A1
(43) Pub. Date: Nov. 27, 2008

(54) Cleaning a Greasy Surface

(76) Inventor: Ronald Alexander Young, West Midlands (GB)

Correspondence Address: YOUNG & THOMPSON, 209 Madison Street, Suite 500, ALEXANDRIA, VA, 22314, US

(21) Appl. No.: 12/092,598

(22) PCT Filed: Oct. 4, 2006
(86) PCT No.: PCT/GB06/03686

§ 371 Date: Jun. 1, 2008

(30) Foreign Application Priority Data
Nov. 3, 2005 (GB) 0522386.2
Jul. 27, 2006 (GB) 0614875.3

(51) Int. Cl. C23G 5/00; C11D 17/08; A47J 47/18; B65D 90/00

(52) U.S. Cl. 134/40; 510/417; 15/264; 220/702

(57) ABSTRACT

A method of cleaning a greasy surface, includes the steps of: a) providing a container and a cleaning implement dimensioned to fit in the container; b) providing a volume of cleaning liquid in the container, the cleaning liquid comprising water, a chemical degreasing agent, and a chemical flocculating agent; and c) using the cleaning implement to pick up particulate matter and water-insoluble matter from the greasy surface and transfer it to the container, the degreasing agent causing the water-insoluble matter to solubilize, the flocculating agent causing the particulate matter to agglomerate and the agglomerated matter to flocculate and to sediment, so as to be held in the cleaning liquid at and/or adjacent to a bottom surface of the container. Preferably, in step (c), the cleaning liquid above the sediment is a single phase. A cleaning solution, a mop bucket, and a grid for use with the method are also provided.

The present invention relates to a method of cleaning a greasy surface, to a cleaning solution for use with the method, and to a mop bucket and grid for use with the method.

There are chemical additives for adding to water to enhance the break up of secondary floor films created in conjunction with soil particles and insoluble materials, such as fit and oil. Such an additive is Scrunge®.

Although such degreasing chemical additives allow the break up and collection of the secondary floor film by, for example, a mop, once transferred to a cleaning receptacle, such as a mop bucket, the soil particles and insoluble material are dispersed throughout the cleaning liquid in the mop bucket. The water-insoluble material emulsifies, forming a scum as an additional phase on the surface of the cleaning liquid. This is highly undesirable, since the dispersed particulate matter and emulsified matter is consequently re-collected by the mop and thus re-applied to the surface just cleaned.

It is thus problematic to achieve a fully or even substantially ‘dirt’ free surface.

The present invention seeks to provide a solution to this problem.

According to a first aspect of the present invention, there is provided a method of cleaning a greasy surface, the method comprising the steps of: a) providing a container and a cleaning implement dimensioned to fit in the container; b) providing a volume of cleaning liquid in the container, the cleaning liquid comprising water, a chemical degreasing agent, and a chemical flocculating agent; and c) using the cleaning implement to pick up particulate matter and water-insoluble matter from the greasy surface and transfer it to the container, the degreasing agent causing the water-insoluble matter to solubilize, the flocculating agent causing the particulate matter to agglomerate and the agglomerated matter to flocculate and to sediment, so as to be held in the cleaning liquid at and/or adjacent to a bottom surface of the container.

The term ‘greasy’ used herein throughout is intended to include oil, fat, lard, grease, and any other generally water-insoluble viscous material.

Preferable and/or optional features of the first aspect of the invention are provided in claims 2 to 14, inclusive.

According to a second aspect of the invention, there is provided a method of cleaning a greasy surface, the method comprising the steps of: a) providing a container and a cleaning implement dimensioned to fit in the container; b) providing a volume of cleaning liquid in the container, the cleaning liquid comprising water, a chemical degreasing agent, and a chemical flocculating agent; and c) using the cleaning implement charged with the cleaning liquid to clean the greasy surface, the degreasing agent causing particulate matter on the greasy surface to agglomerate and water-insoluble matter to emulsify, the flocculating agent causing the agglomerated and emulsified matter to flocculate and, when transferred by the cleaning implement to the container, to sediment and be held in the cleaning liquid in the container at and/or adjacent to a bottom surface of the container.

According to a third aspect of the invention, there is provided a cleaning solution for use with a method in accordance with the first or second aspects of the invention, the cleaning solution comprising a chemical degreasing agent and a chemical flocculating agent combined to form a single independent solution for addition to water to form cleaning liquid, the chemical degreasing agent causing water-insoluble matter introduced into the cleaning liquid to solubilize, the flocculating agent causing the particulate matter introduced into the cleaning liquid to agglomerate and the agglomerated matter to flocculate and to sediment.

Preferable and/or optional features of the third aspect of the invention are provided in claims 17 to 22, inclusive.

According to a fourth aspect of the invention, there is provided a mop bucket for use with a method in accordance with the first or second aspects of the invention, the mop bucket comprising a grid which separates the interior of the mop bucket into upper and lower chambers, the grid contacting interior surface(s) of the mop bucket along or adjacent to its entire or substantially entire perimeter so as to prevent or limit the passage of cleaning liquid between the grid and the mop bucket.

According to a fifth aspect of the invention, there is provided a grid for a mop bucket for use with a method in accordance with the first or second aspects of the invention, the grid being dimensioned to contact interior surface(s) of the mop bucket along or adjacent to its perimeter so as to prevent or limit the passage of cleaning liquid between the mop bucket and the grid, the grid including an endless border which extends inwardly from, or adjacent to, its perimeter edge in a range of 5 mm to 30 nm.

The present invention will now be more particularly described, by way of example only, with reference to the accompanying drawings, in which:

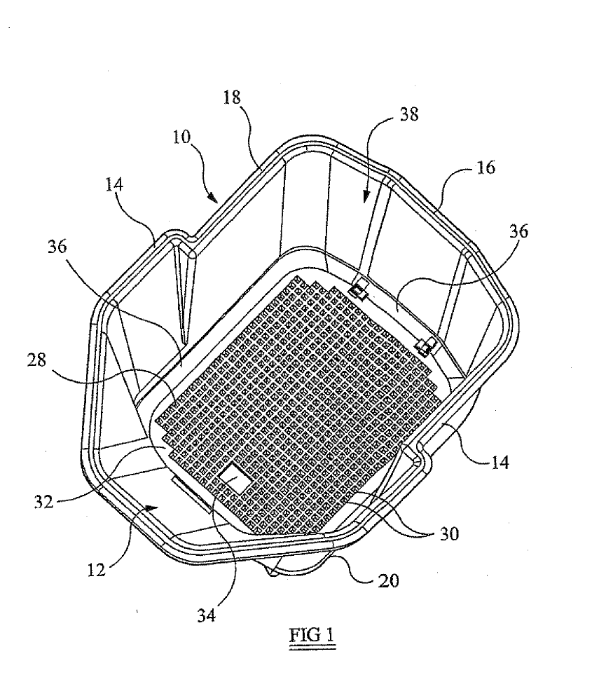

FIG. 1 is a perspective view from above of one embodiment of a mop bucket, according to the fourth and fifth aspects of the invention and for use with a method in accordance with the first and second aspects of the invention;

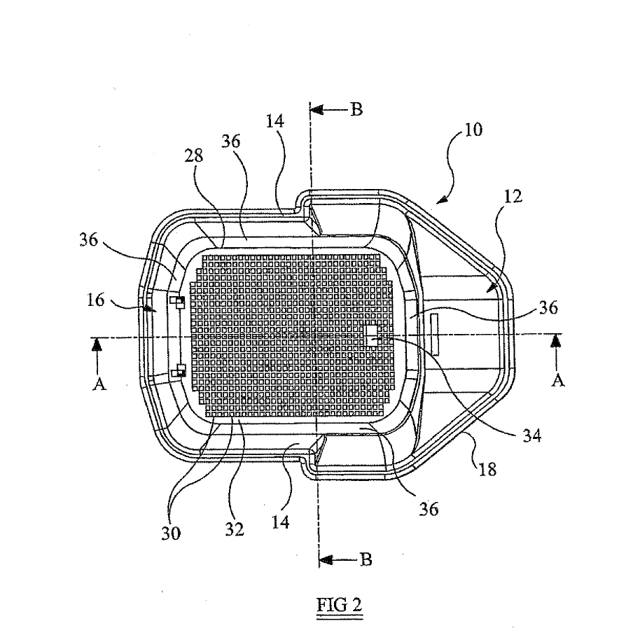

FIG. 2 is a top plan view of the mop bucket shown in FIG. 1;

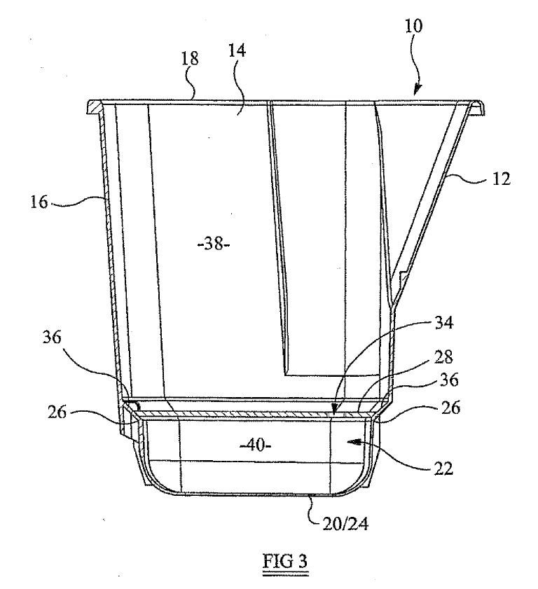

FIG. 3 is a vertical sectional view of the mop bucket, taken along line A-A in FIG. 2, with wheels removed for clarity; and

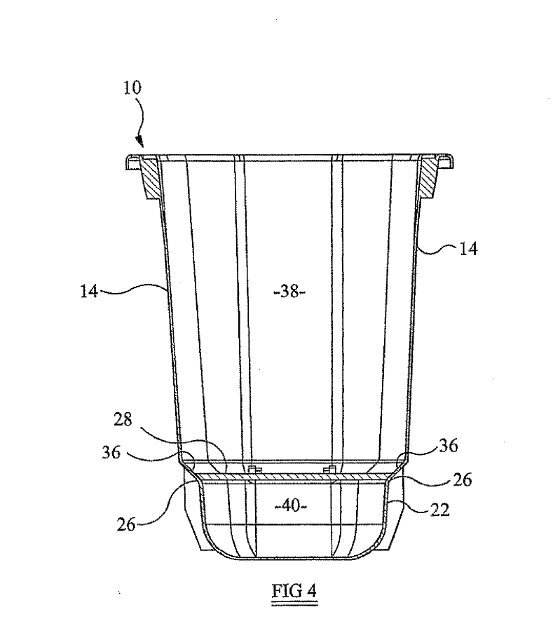

FIG. 4 is a vertical sectional view of the mop bucket, taken along line B-B in FIG. 2, again with wheels removed for clarity.

Referring to the drawings, there is shown a mop bucket 10 having a typical working capacity in the range of 10 litres to 20 litres, and more specifically 16 litres.

The mop bucket 10 has a part-funnel shaped front wall 12, and substantially vertical side walls 14 and rear wall 16. The walls 12, 14, 16 taper inwardly slightly in an upper edge 18 to lower edge 20 direction. A sump 22 is defined at the base 24 of the mop bucket 10. The sump 22 is in the range of 80 to 90 millimetres (mm) deep, and preferably being 85.5 mm deep. The sump 22 has a length in the range of 240 mm to 280 mm, and preferably a length of 253.6 mm, and a width in the range of 170 mm to 230 mm, and preferably being 196.1 mm. The sump 22 preferably defines a volume which is greater than 3500 cm³, and which is preferably in a range of 3500 cm³ to 4700 cm³. More preferably, the sump has a volume in the range of 4100 cm³ to 4300 cm³.

The walls 12, 14, 16 of the mop bucket 10 taper sharply inwardly at an upper edge 26 of the sump 22 to allow for exterior wheels (not shown), such as castors, to be fitted at the four corners.

The mop bucket 10 includes a movable grid 28 hingeably attached to the rear wall 16. Instead of hinging, the grid can be removable. The grid 28 includes a multitude of closely spaced apertures 30 and an endless border 32 around the perimeter of the grid 28 and which extends inwardly from the perimeter edges in the range of 5 mm to 30 mm.

The grid 28 also includes a finger hole aperture 34 to enable manual raising of the grid 28.

The grid 28 is dimensioned to be a contact fit with the interior surfaces 36 of the mop bucket 10. Conveniently, the grid 28 sits on the inward taper at the upper edge 26 of the sump 22. The grid 28, when in the lowered condition, separates the interior of the mop bucket 10 into upper and lower chambers 38, 40 which are in fluid communication only via the apertures 30 of the grid 28. The lower chamber 40 is or includes the sump 22.

Typically, a wringer device (not shown), being either a manual or mechanical wrier, is fitted to the mop bucket 10 in a cap-like manner. Since the provision of a wringer device on a mop bucket 10 is well known, further detail is omitted.

The mop bucket 10 is used with a cleaning implement, typically being a mop (not shown). Again, mops are well known, and flier detail is omitted.

The mop bucket 10 and cleaning implement are used with a cleaning liquid. In the present invention, the cleaning liquid comprises water, a degreasing agent, and a flocculating agent. The degreasing agent and the flocculating agent are combined into a single independent cleaning solution which is added to the water as a chemical additive, typically in a ratio of 90% water to 10% additive. Typically, the mop bucket 10 is filled to the working capacity with water, such as hot tap water, and the required dosage of degreasing flocculating chemical additive is then added. However, the degreasing flocculating chemical additive can be poured into the mop bucket 10 first, with the water being added thereafter, or the solution of water and degreasing flocculating chemical additive can be prepared externally of the mop bucket 10 before then being poured into the mop bucket 10.

The degreasing flocculating chemical additive comprises, and typically consists of, water at 23.466% w/w, citric acid at 20% w/w, isothiazolinones at 0.02% w/w, kenapan green liquid at 0.003% w/w, C9-C11-Pareth-8 at 22.5% w/w, butyl glycol at 10% w/w, alkylpoly glucoside 50% at 20% w/w, and cationic ethoxylated propoxylated acrylic monopolymer at 4% w/w.

Isothiazolinones acts as a preservative; C9-C11-Pareth-8 and alkylpoly glucoside 50% act as surfactants; butyl glycol is a solvent; and cationic ethoxylated propoxylated acrylic monopolymer is the flocculating agent. However, it will be understood that a synergistic effect is achieved through the use of these chemicals.

It will also be appreciated that the ratios can be altered. Preferably, the cationic ethoxylated propoxylated acrylic monopolymer flocculating agent is in a range of 2 to 8% w/w. C9-C11-Pareth-8 is in a range of 15 to 25% w/w; and the alkylpoly glucoside 50% is in a range of 15 to 25% w/w.

In use, the cleaning liquid having the degreasing flocculating chemical additive is transferred from the mop bucket 10 or other container to the dirty surface, typically a greasy floor of a kitchen or restaurant, using the mop or other cleaning implement. The surfactants lift the insoluble, typically grease, fat and/or oil, and particulate matter based on the sorption of water and surfactant, soil penetration and primary emulsification with the aid of abrasive movement of the mop or cleaning implement. The particulate matter agglomerates and the insoluble matter emulsifies into a micro-emulsion that is picked up more readily by the mop material or cleaning implement.

The mop or cleaning implement transfers the particulate and water-insoluble matter to the mop bucket 10. Through rinsing, the particulate matter agglomerates and then flocculates due to the cationic ethoxylated propoxylated acrylic monopolymer, resulting in the agglomerated flocculated matter then rapidly sinking to the grid 28. The insoluble flocculated agglomerated matter passes through the apertures 30 in the grid 28 and into the lower chamber/sump 22 of the mop bucket 10, where it gathers as a suspension and/or sediment at and/or adjacent to the bottom surface of the mop bucket 10.

Some emulsification may occur, and any emulsified matter preferably flocculates with the agglomerated matter to the base of the mop bucket 10.

The water-insoluble matter, such as oil, is solubilzed by the degreasing agent, and is transformed into the cleaning liquid. Consequently, the cleaning liquid above the flocculated agglomerated particulate matter is a one- or single-phase liquid. No emulsification occurs. Solubilisation, rather than emulsification, is highly beneficial, since it allows the mop or cleaning implement to be re-immersed and rinsed in the cleaning liquid, above the flocculated agglomerated matter, and reapplied to the surface to be cleaned, without re-transferring the water-insoluble matter back- to the surface.

An additional benefit is that, as the initially flocculated matter sinks, it collects more particulate and insoluble matter suspended in the cleaning liquid, moving it also to the sump area.

Since the grid, when in the lowered condition, contacts the interior side surfaces of the mop bucket, turbulence imparted to the cleaning liquid in the sump, due to agitation of the mop or cleaning implement in the upper chamber, does not cause, or results in limited, recirculation of the flocculated matter, since the matter cannot pass between the perimeter edge of the grid and the interior side surfaces of the mop bucket.

Through testing, it has been determined that the preferable minimum depth of the sump is in the range of 80 to 90 mm, and that depths which are less than this allow flocculated matter to be forced more easily back through the apertures of the grid.

The grid therefore enables the flocculated matter in the lower chamber and/or sump to be kept separate of the upper chamber. Consequently, the cleaning liquid in the upper chamber remains clean or substantially clean and ditty matter collected from the surface being cleaned and transferred to the mop bucket is not re-applied to the surface on re-application of the rinsed mop.

Although a mop bucket is described above, any suitable container can be used with any cleaning implement dimensioned to fit the container for rinsing and recharging. If a sump is not provided, then simply separating the interior of the container into upper and lower chambers is sufficient.

It is envisaged that the grid can be dispensed with, providing that the flocculated matter is sufficiently dense to prevent recirculation and mixing with a majority of the cleaning liquid.

A grid which seals or contacts an interior surface or surfaces of the container or mop bucket, at its perimeter or adjacent to its perimeter depending on the configuration of the container or mop bucket, can be sold as an independent item to fit existing containers or mop buckets, or as a replacement part.

It is thus possible to provide a method of removing particulate and water-insoluble matter from a surface, without then re-applying the removed particulate and water-insoluble matter to the cleaned surface following rinsing. By the use of a chemical additive which contains a mixture of surfactants, being non-ionic and cationic, bound into a polyelectrolyte molecule, the up-lift of grime from a surface is promoted, and the use of a flocculating agent causes the removed dirt to flocculate into a water-insoluble dense mass which sinks to form a sediment leaving clean or relatively clean cleaning liquid. The degreasing agent causes no emulsification, but does result in solubilisation of the water-insoluble matter transferred from a dirty surface. The solubilisation results in a single phase liquid above the dense flocculated agglomerated particulate matter. Due to the single phase liquid, a mop or cleaning implement does not pass through a separate layer of scum or dirty water-insoluble matter during entry into and extraction from the container.

The embodiment described above is given by way of example only, and modifications will be apparent to persons skilled in the art without departing from the scope of the invention as defined by the appended claims.

1-26. (canceled)

27. A method of cleaning a greasy surface, the method comprising the steps of:
a) providing a container and a cleaning implement dimensioned to fit in the container, the container including a grid which separates the interior of the container into upper and lower chambers, the grid being spaced from an interior bottom surface of the container in range of 80 mm to 90 mm;
b) providing a volume of cleaning liquid in the container, the cleaning liquid comprising water, a chemical degreasing agent, and a chemical flocculating agent and
c) using the cleaning implement to pick up particulate matter and water-insoluble matter from the greasy surface and transfer it to the container, the degreasing agent causing the water-insoluble matter to solubilize, the flocculating agent causing the particulate matter to agglomerate and the agglomerated matter to flocculate and to sediment, so as to be held in the cleaning liquid adjacent to a bottom surface of the container, and wherein the flocculated agglomerated matter sinks through the grid and is held as sediment is the lower chamber.

28. A method as claimed in claim 27, wherein the degreasing agent does not emulsify the water-insoluble matter.

29. A method as claimed in claim 27, wherein, in step (c), the cleaning liquid above the sediment is a single phase.

30. A method as claimed in claim 27, wherein a volume of the lower chamber is in a range of 3500 cm³ to 4700 cm³.

31. A method as claimed in claim 30, wherein the volume of the lower chamber is in a range of 4100 cm³ to 4300 cm³.

32. A method as claimed in claim 27, where in the container is shaped to include a sump which defines the, or part of the, lower chamber, the grid extending across the sump to separate the lower chamber from the upper chamber.

33. A method as claimed in claim 27, wherein a perimeter edge or edges of the grid meets an interior surface or surfaces of the container so that the perimeter of the grid seals or substantially seals against the container to prevent recirculation from the lower chamber to the upper chamber between the container and the grid.

34. A method as claimed in claim 27, wherein the grid includes a solid endless border extending from the perimeter of the grid.

35. A method as claimed in claim 34, wherein the endless border extends inwardly from, or adjacent to, the perimeter of the grid in a range of between 5 mm and 30 mm.

36. A method as claimed in claim 27, wherein the grid is hinged to an interior surface of the container.

37. A method as claimed in claim 27, wherein a working capacity of the container is in a range of 10 litres to 20 litres.

38. A method as claimed in claim 27, wherein the working capacity of the container is 16 litres.

39. A method of cleaning a greasy surface, the method comprising the steps of:
a) providing a container and cleaning implement dimensioned to fit in the container, the container including a grid which separates the interior of the container into upper and lower chambers, the grid being spaced from an interior bottom surface of the container in a range of 80 mm to 90 mm;
b) providing a volume of cleaning liquid in the container, the cleaning liquid comprising water, a chemical degreasing agent, and a chemical flocculating agent; and
c) using the cleaning implement charged with the cleaning liquid to clean the greasy surface, the degreasing agent causing particulate matter an the greasy surface to agglomerate and water-insoluble matter to emulsify, the flocculating agent causing the agglomerated and emulsified matter to flocculate and, when transferred by the cleaning implement to the container, to sediment and be held in the cleaning liquid in the container at and/or adjacent to a bottom surface of the container, and wherein the flocculated agglomerated matter sinks through the grid and is held as sediment in the lower chamber.

40. A cleaning solution for use with a method as claimed in claim 27, wherein the chemical degreasing agent and chemical flocculating agent are combined to form a single independent solution for addition to water to form the cleaning liquid.

41. A method as claimed in claim 40, wherein the degreasing agent causes no emulsification of water-insoluble matter.

42. A method as claimed in claim 40, wherein the degreasing agent solubilizes water-insoluble matter to form a single phase.

43. A method as claimed in claim 40, wherein the flocculating agent includes a cationic ethoxylated propoxylated acrylic monopolymer.

44. A method as claimed in claim 40, wherein the flocculating agent is in a range of 2 to 8% w/w of the chemical additive.

45. A method as claimed in claim 40, wherein the degreasing agent includes C9-C11-Pareth-8 in a range of 15 to 25% w/w of the chemical additive.

46. A method as claimed in claim 40, wherein the degreasing agent includes alkylpoly glucoside 50% in a range of 15 to 25% w/w of the chemical additive.

47. A mop bucket (10) for use with a method as claimed in claim 27, the mop bucket (10) comprising a grid (28) which separates the interior of the mop bucket (10) into upper and lower chambers (38, 40), the grid (28) contacting interior surface(s) (36) of the mop bucket (10) along or adjacent to its entire or substantially entire perimeter so as to prevent or limit the passage of cleaning liquid between the grid (28) and the mop bucket (10) and wherein the grid is spaced from an interior bottom surface of the container in a range of 80 mm to 90 mm.
